(19) United States
(12) Patent Application Publication
(10) Pub. No.: US 2026/0172130 A1
(43) Pub. Date: Jun. 18, 2026

(54) INTERLEAVED QUANTUM COMPUTER WIRING

(71) Applicant: INTERNATIONAL BUSINESS MACHINES CORPORATION, ARMONK, NY (US)

(72) Inventors: Sean Hart, Tarrytown, NY (US); Oliver Dial, Yorktown Heights, NY (US); David Abraham, Croton, NY (US)

(21) Appl. No.: 18/984,902

(22) Filed: Dec. 17, 2024

(51) Int. Cl. H04J 1/12; H04B 3/32

(52) U.S. Cl. CPC H04J 1/12; H04B 3/32

(57) ABSTRACT

A signal delivery wiring system for a quantum computer includes a first signal line carrying a first signal on a wiring cable on a first frequency band and a second signal line carrying a second signal on the wiring cable on a second frequency band. The first signal line is interspersed with the second signal line on the wiring cable. The first frequency band is different from the second frequency band such that crosstalk is avoided between the first signal line and the second signal line.

### BACKGROUND

The present disclosure generally relates to systems and methods for wiring quantum computer circuits, and more particularly, to a flex wiring for low-temperature quantum computers that provides crosstalk rejection without changing the fabrication or design of the flex cable.

Flex wiring for low-temperature quantum computers is currently being used and/or is in development in order to service the increasing numbers of qubits. Technical requirements for the flex wiring include parameters such as thermal load, insertion loss, and crosstalk between adjacent signal lines. The requirements for the various signal types (fast flux lines for tuning qubits and/or couplers, voltage tuning lines to adjust two-level system's (TLS's) existing in or near the qubit and drive lines which create rotations of the qubit state, readout) are different in terms of loss, frequency band and crosstalk.

### SUMMARY

In one embodiment, a signal delivery wiring system for a quantum computer includes a first signal line carrying a first signal on a wiring cable on a first frequency band and a second signal line carrying a second signal on the wiring cable on a second frequency band. The first signal line is interspersed with the second signal line on the wiring cable. The first frequency band is different from the second frequency band such that crosstalk is avoided between the first signal line and the second signal line. In some embodiments, the first signal line includes a plurality of first signal lines and the second signal line includes a plurality of second signal lines.

In another embodiment, a signal delivery wiring system for a cryostat of the quantum computer includes a first signal line carrying a first signal on a wiring cable at a first frequency, a second signal line carrying a second signal on the wiring cable at a second frequency, and a third signal line carrying a third signal on the wiring cable at a third frequency. The first signal line is interspersed with the second signal line and the third signal line on the wiring cable. The first frequency band is different from the second frequency band and the third frequency band is different from the first frequency band. Crosstalk between adjacent signal lines along the wiring cable is avoided. All the frequency bands can be distinct given a width of each frequency band around a given center frequency thereof.

In another embodiment, a method for reducing crosstalk in a wiring cable of a quantum computer includes carrying a first signal on a first signal line of a wiring cable at a first frequency, carrying a second signal on a second signal line of the wiring cable at a second frequency, and carrying a third signal on a third signal line of the wiring cable at a third frequency. The first signal line is interspersed with the second signal line and the third signal line on the wiring cable. The first frequency is different from the second frequency and the third frequency is different from the first frequency.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A shows a current scheme for quantum computer wiring, where signals for each function are aggregated individually, where the number “1” corresponds to a first signal type;

FIG. 1B shows a current scheme for quantum computer wiring, where signals for each function are aggregated individually, where the number “2” corresponds to a first signal type;

FIG. 1C shows a current scheme for quantum computer wiring, where signals for each function are aggregated individually, where the number “3” corresponds to a first signal type;

FIG. 2A shows a wiring scheme for quantum computer wiring, where signals are interspersed within each flex cable in order to physically separate like signal types, consistent with an illustrative embodiments;

FIG. 2B shows a wiring scheme for quantum computer wiring, where signals are interspersed within each flex cable in order to physically separate like signal types, consistent with an illustrative embodiments;

FIG. 2C shows a wiring scheme for quantum computer wiring, where signals are interspersed within each flex cable in order to physically separate like signal types, consistent with an illustrative embodiments;

FIG. 3A shows a wiring scheme for quantum computer wiring, where signals are interspersed within each flex cable with non-signal features (“F”) in order to physically separate like signal types, further improve crosstalk, and maintain signal ratio requirements, consistent with an illustrative embodiments;

FIG. 3B shows a wiring scheme for quantum computer wiring, where signals are interspersed within each flex cable with non-signal features (“F”) in order to physically separate like signal types, further improve crosstalk, and maintain signal ratio requirements, consistent with an illustrative embodiments;

FIG. 3C shows a wiring scheme for quantum computer wiring, where signals are interspersed within each flex cable with non-signal features (“F”) in order to physically separate like signal types, further improve crosstalk, and maintain signal ratio requirements, consistent with an illustrative embodiments;

FIG. 4 shows a current scheme for quantum computer wiring where signals for each function are delivered in groups at an endpoint (payload terminus), resulting in a complex routing of signals throughout the payload terminus;

FIG. 5 shows a wiring scheme for quantum computer wiring, where signals for each function are delivered in groups at an endpoint (payload terminus) and the interspersed signals in the flex wiring improves routing of signals throughout the payload terminus, consistent with an illustrative embodiment;

FIG. 6 shows a cryostat receiving signals from a signal source outputting interspersed signals, consistent with an illustrative embodiment; and

FIG. 7 shows a cryostat receiving signals from a signal source outputting signals with separate routing, where a patch device is used to separate the signal types, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can reduce or eliminate crosstalk between (e.g., adjacent) signal lines in wiring of quantum computers. Achieving sufficiently low crosstalk in the flex cable is subject to limitations of the cable structure (i.e., how well the lines are isolated from one another by via fencing and the like) as well as scale (moving lines further apart can help but at the cost of overall flex width/signal line). It would be helpful to have a method of increasing crosstalk rejection without changing the fabrication or design of the flex cable. This is particularly valuable on cables in a cryogenic environment where grounded lines between signals (normally used liberally to reduce crosstalk) add large heat loads.

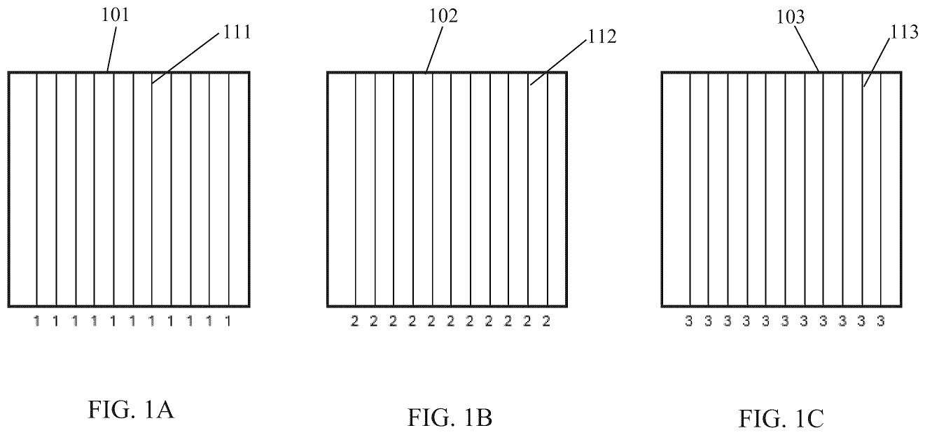

As shown in FIGS. 1A through 1C, in typical quantum computing circuits, signals for each function are aggregated individually. In FIG. 1A, a flex cable 101 can be used for lines 111 of a first signal type, designated as “1”. In FIG. 1B, a flex cable 102 can be used for lines 112 of a second signal type, designated as “2”. In FIG. 1C, a flex cable 103 can be used for lines 113 of a third signal type, designated as “3”. Crosstalk can occur between signal lines on each of the flex cables.

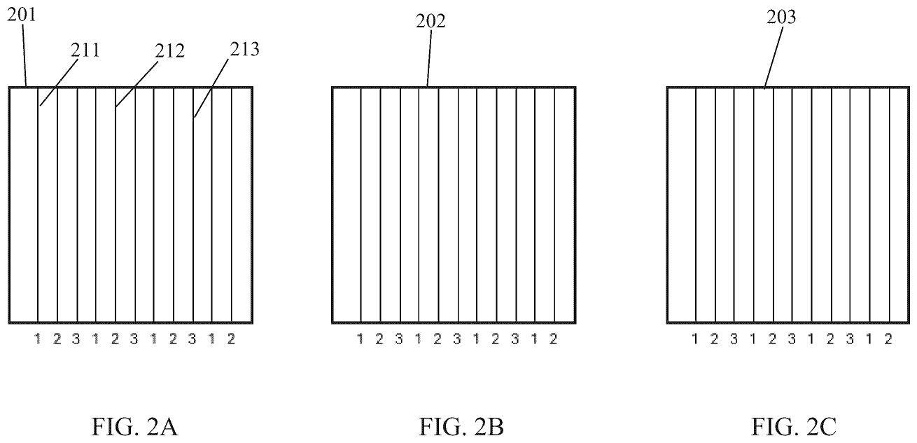

Referring now to FIGS. 2A through 2C, the signal types, examples of which are discussed below, can be interspersed within each flex cable in order to physically separate like signal lines. In FIG. 2A, a flex cable 201 can be used for lines 211, 212, 213, respectively, of interspersed signals of the first signal type, designated as “1”, the second signal type, designated as “2”, and the third signal type, designated as “3”. In FIG. 1B, a flex cable 202 can be used for the same interspersed signals. In FIG. 1C, a flex cable 203 can be used for the same interspersed signals. In this case, crosstalk can be reduced or eliminated as compared to the potential crosstalk generated in the wiring schemes of FIGS. 1A through 1C.

In has been observed that signals of a given type will not likely interact strongly with those of another type. For example, a two level system bias signal type is basically direct current (DC) and interference from a 4-7 GHz drive tone signal type will not create a crosstalk problem. Therefore, the two level system bias lines act as conventionally used grounded lines for the drive lines, and vice versa. However, unlike conventional grounded lines, by using different signal types, the additional heat load generated by the grounded lines (which would serve no other purpose other than isolation) is not present. The scheme shown in FIGS. 2A through 2C moves like-type signals further apart without increasing flux footprint. The same scheme can be used for the 100 MHz fast flux (FF) signals compared to either the DC TLS bias or the GHz-range drive signals. It should be noted that this interleave should occur on the flex cable and connectors all the way from top to bottom of the cryostat, as described in greater detail below.

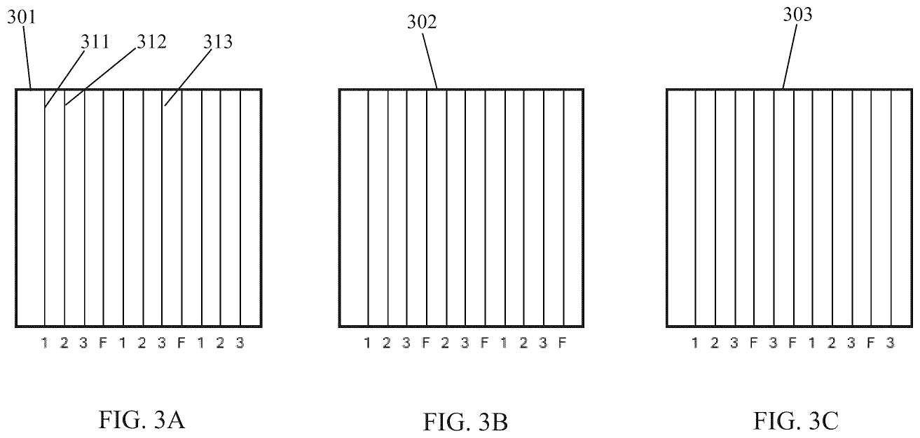

Referring now to FIGS. 3A through 3C, the signal types can be interspersed within each flex cable in order to physically separate like signal lines and non-signal features, designated as “F”, examples of which are described below, can be provided to further reduce crosstalk and to maintain signal ratio requirements of the quantum circuit. In FIG. 3A, a flex cable 301 can be used for lines 311, 312, 313, respectively, of interspersed signals of the first signal type, designated as “1”, the second signal type, designated as “2”, and the third signal type, designated as “3”. A non-signal feature, designated as “F” can be placed between signal lines in various configurations, such as between each set of first, second, and third signal types.

In FIG. 3B, a flex cable 302 can be used for the first, second, and third signal types, with the non-signal features interspersed at different positions. In FIG. 3C, a flex cable 303 can be used for the first, second, and third signal types, with the non-signal features interspersed at different positions. In these cases, crosstalk can be reduced or eliminated as compared to the potential crosstalk generated in the wiring schemes of FIGS. 1A through 1C.

As can be seen, the ratio of different signal types within a system may not be 1:1. By inserting non-signal features as needed, the crosstalk can be further improved while meeting system level signal delivery needs. The non-signal features “F” can be, for example, the absence of a signal line, a signal line used as ground, a via fence, a slit in the ground plane, a combination of these items, or the like.

While FIGS. 2A through 3C show signals that can be interleaved left-to-right in an alternating arrangement, it should be understood that interleaving top-to-bottom can also be performed. For example, top-to-bottom interleaving can include a ground play, a layer of flux signals, a layer of radio frequency signals, and a ground plane as one moves from the bottom to the top of a flex stack.

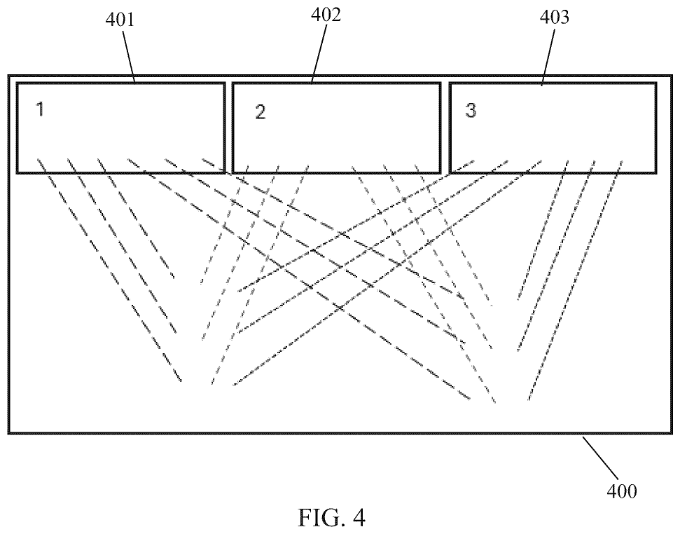

Referring to FIG. 4, the signal lines, being individually carried on separate flex cables, as shown in FIGS. 1A through 1C, can arrive at a payload terminus 400. FIG. 4 shows a first cable 401 carrying the first signal type, designated as “1”, a second cable 402 carrying the second signal type, designated as “2”, and a third cable 403 carrying the third signal type, designated as “3”. For clarity, only six signal lines for each signal type are illustrated. As can be seen, when the conventional signal lines of FIGS. 1A through 1C are used to carry the different signals, the routing of the signals at the payload terminus is complex.

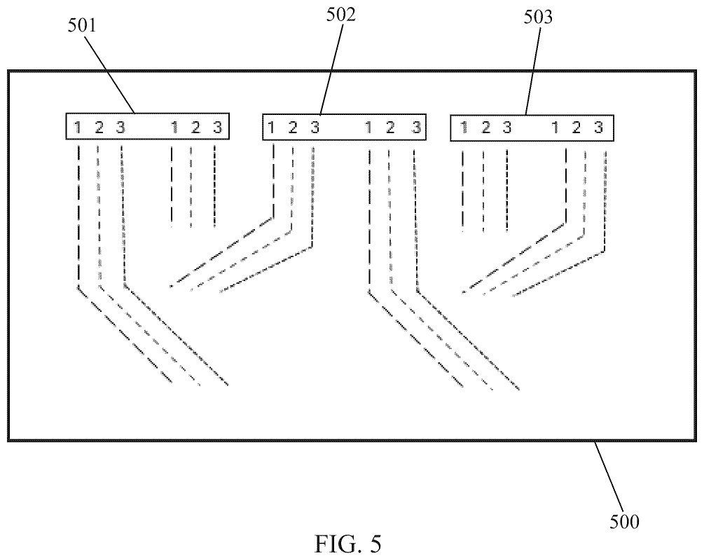

Referring to FIG. 5, the signal lines, being interspersed on the separate flex cables, as shown in FIGS. 2A through 2C, can arrive at a payload terminus 500. FIG. 5 shows a first cable 501 carrying the first signal type, designated as “1”, a second cable 502 carrying the second signal type, designated as “2”, and a third cable 503 carrying the third signal type, designated as “3”. For clarity, only six signal lines for each signal type are illustrated, while it will be understood that any number of signal lines are supported by the teachings herein. As can be seen, when the interspersed signal lines of FIGS. 2A through 2C are used to carry the different signals, the routing of the signals at the payload terminus are more simple as compared to the payload terminus 400 of FIG. 4, without requiring multiple crossings of the signal lines.

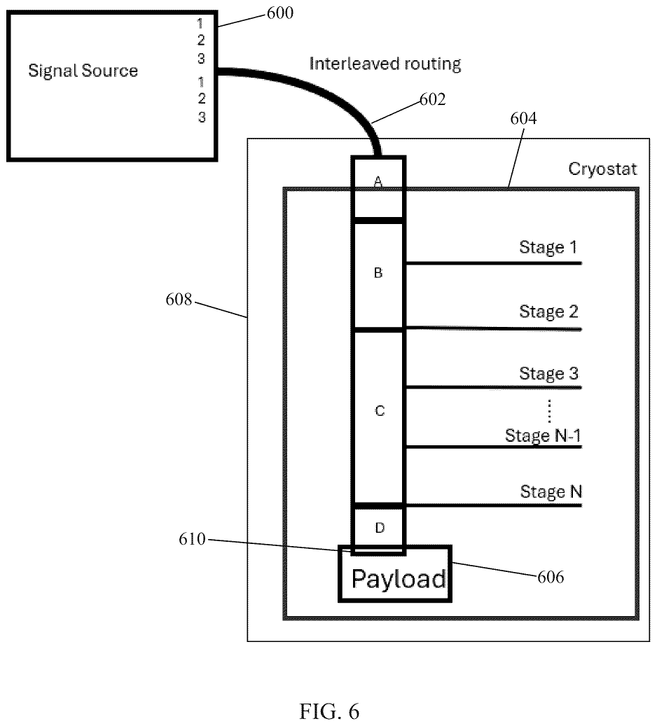

Referring to FIG. 6, in some embodiments, a signal source 600 can have the signal types already interspersed, where interleaved routing 602 can be used to deliver the signals from the signal source 600 to the cryostat 604. Within the cryostat 604, segments A, B, C, and D refer to flex cables with interspersed signals, such as those shown in FIGS. 2A through 2C, FIGS. 3A through 3C, or the like. The flex cables can be used to move the interleaved routing 602, received at flex cable A, through to the payload terminus 606. At the payload terminus 606, the signals can be routed where needed within a quantum circuit of a quantum computer 608. Prior to the payload terminus 606, a signal altering device 610 may be used to alter the signal on one or more of the signal lines. Such signal altering device 610 can be a diplexer or filter to help remove crosstalk from adjacent signal lines. In other embodiments, the signal altering device 610 can be a radio frequency switch that can be used to turn off (open) one or more signal lines when such signal line is not being used (a signal is absent on the signal line), thus limiting crosstalk reception at the payload terminus 606. In still other embodiments, adjacent signal lines along the wiring cable can have different duty cycles in time.

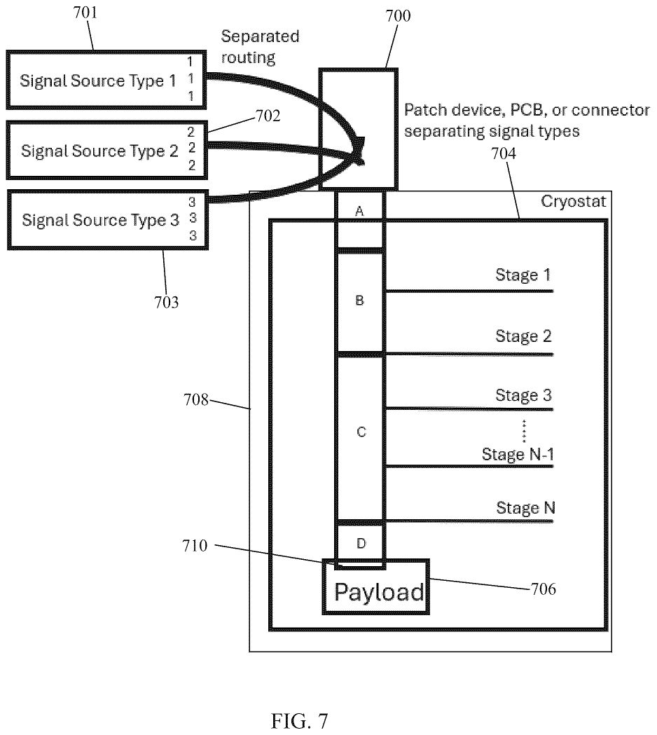

Referring to FIG. 7, in some embodiments, a first signal source 701 can provide multiple signal lines of a first signal type, designated as “1”, a second signal source 702 can provide multiple signal lines of a second signal type, designated as “2”, and a third signal source 703 can provide multiple signal lines of a third signal type, designated as “3”. Each of the signal lines of the first signal source 701, the second signal source 702, and the third signal source 703 can be fed to a signal separating device 700. The signal separating device 700 may be a patch device, a printed circuit board, a connector, or the like, that can receive the separated routing from each of the first, second, and third signal source 701, 702, 703, and intersperse the signal lines in the flex cable, such as those shown in FIGS. 2A through 2C, FIGS. 3A through 3C, or the like. The flex cables can be used to move the interleaved routing provided by the signal separating device 700, received at flex cable A, through to the payload terminus 706. At the payload terminus 706, the signals can be routed where needed within a quantum circuit of a quantum computer 708.

Prior to the payload terminus 706, a signal altering device 710 may be used to alter the signal on one or more of the signal lines. Such signal altering device 710 can be a diplexer or filter to help remove crosstalk from adjacent signal lines. In other embodiments, the signal altering device 710 can be a radio frequency switch that can be used to turn off (open) one or more signal lines when such signal line is not being used (a signal is absent on the signal line), thus limiting crosstalk reception at the payload terminus 706.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A signal delivery wiring system for a quantum computer comprising:
a first signal line configured to carry a first signal on a wiring cable at a first frequency band; and
a second signal line configured to carry a second signal on the wiring cable at a second frequency band, wherein:
the first signal line is interspersed with the second signal line on the wiring cable; and
the first frequency band is different from the second frequency band.

2. The signal delivery wiring system of claim 1, wherein the wiring cable is within a cryostat of the quantum computer.

3. The signal delivery wiring system of claim 1, further comprising a third signal line configured to carry a third signal at a third frequency band, wherein:
the third signal line is interspersed with the first signal line and the second signal line on the wiring cable; and
the third frequency band is different from the first frequency band and the second frequency band.

4. The signal delivery wiring system of claim 3, wherein the first signal line is configured to carry a fast flux signal, the second signal line is configured to carry a top level system bias line, and the third signal line is configured to carry a drive signal.

5. The signal delivery wiring system of claim 1, further comprising at least one of a diplexer or a filter operative to remove crosstalk from an adjacent signal line.

6. The signal delivery wiring system of claim 1, wherein adjacent signal lines along the wiring cable have different duty cycles in time.

7. The signal delivery wiring system of claim 6, further comprising a radio frequency switch on at least one of the first signal line or the second signal line, the radio frequency switch operable to open when a signal is absent.

8. The signal delivery wiring system of claim 1, wherein each signal line is interleaved in an alternating arrangement.

9. The signal delivery wiring system of claim 1, further comprising a non-signal feature interleaved among the first signal line and the second signal line.

10. The signal delivery wiring system of claim 1, further comprising a signal source having interleaved routing of the first signal and the second signal.

11. The signal delivery wiring system of claim 1, further comprising:
a first signal source providing the first signal;
a second signal source providing the second signal; and
a signal separating device receiving the first signal and the second signal and providing interleaved routing of the first and second signals to a cryostat of the quantum computer.

12. A signal delivery wiring system configured to avoid crosstalk between adjacent signals between a signal source and a quantum computer in a cryogenic environment, the signal delivery wiring system comprising:
a first signal line carrying a first signal having a first frequency band, on a wiring cable;
a second signal line carrying a second signal having a second frequency band, on the wiring cable; and
a third signal line carrying a third signal having a third frequency band, on the wiring cable, wherein:
the first signal line is interspersed with the second signal line and the third signal line on the wiring cable; and
the first frequency band is different from the second frequency band and the third frequency band is different from the first frequency band.

13. The signal delivery wiring system of claim 12, further comprising at least one of a diplexer or a filter operative to remove crosstalk from an adjacent signal line.

14. The signal delivery wiring system of claim 12, wherein adjacent signal lines along the wiring cable have different duty cycles in time.

15. The signal delivery wiring system of claim 14, further comprising a radio frequency switch on at least one of the first signal line, the second signal line, or the third signal line, the radio frequency switch operable to open when a signal is absent.

16. The signal delivery wiring system of claim 12, further comprising a non-signal feature interleaved among the first signal line, the second signal line, and the third signal line.

17. The signal delivery wiring system of claim 12, further comprising a signal source having interleaved routing of the first signal, the second signal, and the third signal.

18. The signal delivery wiring system of claim 12, further comprising:
a first signal source providing the first signal;
a second signal source providing the second signal;
a third signal source providing the third signal; and
a signal separating device receiving the first signal, the second signal, and the third signal and providing interleaved routing of the first, second, and third signals to a cryostat of the quantum computer.

19. A method for reducing crosstalk in a wiring cable of a quantum computer, the method comprising:
carrying a first signal on a first signal line of a wiring cable at a first frequency band;
carrying a second signal on a second signal line of the wiring cable at a second frequency band;
carrying a third signal on a third signal line of the wiring cable at a third frequency band; and
interspersing the first signal line with the second signal line and the third signal line on the wiring cable, wherein
the first frequency band is different from the second frequency band and the third frequency band is different from the first frequency band.

20. The method of claim 19, further comprising interleaving a non-signal feature among the first signal line, the second signal line, and the third signal line.
